(19) United States
(12) Patent Application Publication
(10) Pub. No.: US 2007/0295217 A1
(43) Pub. Date: Dec. 27, 2007

(54) Internet based hot coffee order and delivery system.

(76) Inventor: Wolde G. Haileselassie, San Francisco, CA (US)

Correspondence Address: Wolde Haileselassie, 433 Page Street, San Francisco, CA, 94102-5553, US

(21) Appl. No.: 11/425,702

(22) Filed: Jun. 21, 2006

(51) Int. Cl. A47J 31/00

(52) U.S. Cl. 99/279

(57) ABSTRACT

In this internet based hot coffee order and delivery system customers open an online coffee drink account on a website where they will agree to pay a monthly fee to be deducted or taken from their account. On the website customers specify the type of coffee drink, place and time of delivery. The business uses highly equipped vehicles to make and personally deliver hot cup of coffee/and or coffee products direct to the customers location. This system allows customers on site brewed fresh cup of coffee with out the need to leave the comfort of their location. Time and money will also be saved.

In this system, customers set up a prepaid periodic account for coffee and/or coffee product delivery to their homes and offices at prearranged times of the day or on an impromptu basis by placing their orders via the internet and/or telephone.

The business will deliver the service via mobile vehicles that are equipped with the necessary technology to brew quality hot coffee and coffee products and deliver them in person to account and order locations.

The benefits of this system include the time saved by avoiding travel to a coffee shop and back and standing in line to place an order as well as the hassle of coming up with cash when it may not be available when needed. Although the system may allow for cash transactions, the main business is geared towards individuals who set up prepaid periodic accounts for delivery of the services.

This internet based system of order and delivery can be expanded to other products like pizza, sandwiches and more.

1. Personal delivery of hot coffee and coffee products that is brewed on site as ordered through the internet.

2. Use of properly equipped mobile vehicles that make the the coffee and deliver them on a timely basis.

3. Method and process of order and personal delivery of hot cup of coffee and coffee products using the internet and/or telephone and mobile coffee making vehicles.
